(19) United States
(12) Patent Application Publication
(10) Pub. No.: US 2018/0160071 A1
(43) Pub. Date: Jun. 7, 2018

(54) Feature Detection In Compressive Imaging

(71) Applicant: Alcatel-Lucent USA Inc., Murray Hill, NJ (US)

(72) Inventors: Jong-Hoon Ahn, Bedminster, NJ (US); Hong Jiang, Warren, NJ (US)

(73) Assignee: Alcatel -Lucent USA Inc., Murray Hill, NJ (US)

(21) Appl. No.: 15/371,537

(22) Filed: Dec. 7, 2016

(51) Int. Cl. H04N 5/917; H04N 5/378; G06K 9/52; G06K 9/62; G06T 5/00

(52) U.S. Cl. CPC H04N 5/917; H04N 5/378; G06T 2207/20048; G06K 9/6215; G06T 5/00; G06K 9/52

(57) ABSTRACT

The present disclosure provides systems and methods that are configured for feature extraction or object recognition using compressive measurements that represent a compressed image of a scene. In various aspects, a compressive sensing matrix is constructed and used to acquire the compressive measurements, such that in the extraction phase, the compressive measurements can be processed to detect feature points and determine their feature vectors in the scene without using a pixel representation of the scene. The determined feature vectors are used to detect objects based on comparison with one or more predetermined feature vectors.

### TECHNICAL FIELD

The present disclosure is directed to systems and methods for image processing. More particularly, the present disclosure is directed to compressive sensing image processing.

### BACKGROUND

This section introduces aspects that may be helpful in facilitating a better understanding of the systems and methods disclosed herein. Accordingly, the statements of this section are to be read in this light and are not to be understood or interpreted as admissions about what is or is not in the prior art.

Digital image/video cameras acquire and process a significant amount of raw data that is reduced using compression. In conventional cameras, raw data for each of an N-pixel image representing a scene is first captured and then typically compressed using a suitable compression algorithm for storage and/or transmission. Although compression after capturing a high resolution N-pixel image is generally useful, it requires significant computational resources and time.

A more recent approach, known in the art as compressive sensing of an image or, equivalently, compressive imaging, directly acquires compressed data for an N-pixel image (or images in case of video) of a scene. Compressive imaging is implemented using algorithms that use random projections to directly generate compressed measurements for later reconstructing the N-pixel image of the scene without collecting the conventional raw data of the image itself. Since a reduced number of compressive measurements are directly acquired in comparison to the more conventional method of first acquiring the raw data for each of the N-pixel values, compressive sensing significantly eliminates or reduce resources needed for compressing an image after it is fully acquired. An N-pixel image of the scene is reconstructed from the compressed measurements for rendering on a display or other uses.

### BRIEF SUMMARY

In various aspects, systems and methods for compressive sensing image processing are provided.

In one aspect, a computer-implemented system and method for compressive sensing is provided. The computer-implemented system and method includes determining an M×N sensing matrix and using the sensing matrix to generate a plurality M of compressive measurements that represent a compressed version of an N pixel image of a scene. Each of the compressive measurements is respectively generated by enabling or disabling one or more of N aperture elements of an aperture array based on values in respective rows of the sensing matrix and determining a corresponding output of a light sensor configured to detect light passing through the aperture array and provide the corresponding output. The M×N sensing matrix is determined by generating a plurality N number of ordered blocks using an N×N orthogonal matrix, where each of the generated blocks has a set of \sqrt{N}×\sqrt{N} values that are selected from the orthogonal matrix, and where each generated block is ordered in an ascending order based on a determined frequency of the block. The M×N sensing matrix is constructed by selecting an M number of blocks from the N number of ordered blocks.

In one aspect, one or more features of the scene are detected from the plurality M of compressive measurements without generating the N pixel image of a scene.

In one aspect, one or more feature points are extracted using the plurality M of compressive measurements, respective feature vectors for the extracted feature points are determined, and one or more features of the scene are determined by comparing the determined feature vectors with the one or more predetermined feature vectors.

In one aspect, a set of local filter responses are determined using the compressive measurements. In one aspect, a set of block filters is determined, where each block filter in the set of block filters includes one of six types of local box filters. The six types of local box filters include a mean filter, a first order derivative filter in the x-direction, a first order derivative filter in the y-direction, a second order filter in the xx-direction, a second order filter in the yy-direction, and a second order derivative filter in the xy-direction. A transformation matrix for transformation between the sensing matrix and the determined set of block filters is determined; and, the local filter responses are determined by applying the transformation matrix to the compressive measurements.

In one aspect, the set of block filters is determined based on a Speeded Up Robust Features (SURF) algorithm. In another aspect, the set of block filters is determined based on a Scale Invariant Feature Transform (SIFT) algorithm.

In one aspect, a set of scale spaces are determined from the set of local filter responses and the one or more feature points are extracted from the set of the scale spaces. In one aspect, the set of scale spaces are determined by generating a set of first-derivative directional scale spaces and a set of second-derivative directional scale spaces.

In one aspect, a three-dimensional Determinant of Hessian (DoH) scale space is determined from the set of scale spaces, and, the one or more feature points are determined by finding local maxima or local minima in the generated three-dimensional DoH scale space.

### BRIEF DESCRIPTION OF THE DRAWINGS

FIG. 1 illustrates an example of a compressive imaging system in accordance with various aspects of the disclosure.

FIG. 2 illustrates an example process for acquiring compressive sensing measurements in accordance with various aspects of the disclosure.

FIG. 3 illustrates an example process for generating a sensing matrix in accordance with an aspect of the disclosure.

FIGS. 4A & 4B illustrate an example of generating a block representation of an orthogonal matrix.

FIGS. 5A & 5B illustrate an example permutation of the block representation.

FIGS. 6A & 6B illustrate an example ordering of the block representation.

FIGS. 7A & 7B illustrate an example conversion of the block representation into row-by-row-representation.

FIGS. 8A & 8B illustrate an example sensing matrix generated in accordance with the process illustrated in FIG. 3.

FIG. 9 illustrates an example process for feature or object detection from the compressive measurements in accordance with various aspects of the disclosure.

FIG. 10 illustrates an example process for determining feature points and feature vectors using the compressive measurements.

FIGS. 11A & 11B illustrate examples of a sensing matrix and block filters.

FIGS. 12A & 12B illustrate example local box filters.

FIGS. 13A-13F and 14A-14F illustrate examples of local box filters of varying sizes.

FIG. 15 illustrates an example of generating a set of scale spaces.

FIG. 16 illustrates an example of a Determinant of Hessian (DoH) scale space.

FIGS. 17A & 18B illustrate an example determination of feature vectors.

FIG. 18 illustrates an example apparatus for implementing various aspects of the disclosure.

### DETAILED DESCRIPTION

Various aspects of the disclosure are described below with reference to the accompanying drawings, in which like numbers refer to like elements throughout the description of the figures. The description and drawings merely illustrate the principles of the disclosure. It will be appreciated that those skilled in the art will be able to devise various arrangements that, although not explicitly described or shown herein, embody the principles and are included within spirit and scope of the disclosure.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

The present disclosure uses matrix notation. Matrices and vectors are identified in the description. Additionally, [⋅]^{T}, E[⋅], and [symbol] denote matrix or vector transposition, statistical expectation, and the set of real numbers, respectively. In addition, [X]_{i,j}, [x]ᵢ, ∥⋅∥, and ∥⋅∥₂ denote the element in row i and column j of matrix X, the i-th element of column vector x, the L-1 norm, and the L-2 norm, respectively. Further, δᵢⱼ represents the delta function. In particular, δᵢⱼ=1 if i=j and, δᵢⱼ=0 if i≠j. Lastly, [⋅] represents either the absolute value of a scalar or the cardinality of a set, depending on the context.

Compressive sensing, also known as compressed sampling, compressed sensing or compressive sampling, is a known data sampling technique which exhibits improved efficiency relative to conventional Nyquist sampling. Compressive sampling allows sparse signals to be represented and reconstructed using far fewer samples than the number of Nyquist samples. When a signal has a sparse representation, the uncompressed signal may be reconstructed from a small number of measurements that are obtained using linear projections onto an appropriate basis. Furthermore, the reconstruction of the signal from the compressive measurements has a high probability of success when a random sampling matrix is used.

Additional details on conventional aspects of compressive sampling can be found in, for example, E. J. Candés and M. B. Wakin, “An Introduction to Compressive Sampling,” IEEE Signal Processing Magazine, Vol. 25, No. 2, March 2008, E. J. Candés, “Compressive Sampling,” Proceedings of the International Congress of Mathematicians, Madrid, Spain, 2006, and E. Candés et al., “Robust uncertainty principles: Exact signal reconstruction from highly incomplete frequency information,” IEEE Trans. on Information Theory, Vol. 52, No. 2, pp. 489-509, February 2006. Additional details on application of compressive sampling into images, or compressive imaging, can be found in, for example, J. Romberg, “Imaging via Compressive Sampling”, IEEE Signal Processing Magazine, Vol. 25, No. 2, March 2008.

Compressive imaging systems are imaging systems that use compressive sampling to directly acquire a compressed image of a scene. Since the number M of compressive measurements that are acquired are typically far fewer than the number N of pixels of a desired image (i.e., M<<N), compressive measurements represent a compressed version of the N-pixel image. Compressive imaging systems conventionally use random projections to generate the compressive measurements, and the desired N-pixel image of the scene is obtained by reconstructing or decompressing the M number of compressive measurements into the N pixel data of the image. The N-pixel image of the scene that is reconstructed from the compressed measurements can be rendered on a display or subjected to additional processing.

Conventional algorithms for object (or feature) recognition (or detection) in computer vision systems operate on pixel data of an image. Object recognition becomes an issue when compressive sensing is used to directly acquire compressive measurements representing the compressed version of the image. In order to perform object detection in compressive sensing systems, the compressive measurements that are acquired are first processed to reconstruct (or decompress) the compressive measurements into the pixel data representation of the image. After the pixel representation of the image is obtained from the compressive measurements, conventional algorithms are applied in order to perform recognition of objects in the image.

Although object recognition after reconstruction of the pixel data of the image from the compressive measurements is viable and useful, it does impose the step of having to convert the compressive measurements into the pixel values which may not be desirable. Accordingly, systems and methods disclosed herein advantageously enable object recognition from the compressive measurements directly, thus reducing or eliminating the need for a conversion into pixel representation to perform object recognition within the image.

Compressive sampling is generally characterized mathematically as multiplying an N dimensional signal vector by a M×N size sampling or sensing matrix φ to yield an M dimensional compressed measurement vector, where M is typically much smaller than N (i.e., for compression M<<N). As is known in the art, if the signal vector is sparse in a domain that is linearly related to that signal vector, then the N dimensional signal vector can be reconstructed (i.e., approximated) from the M dimensional compressed measurement vector using the sensing matrix φ.

In imaging systems, the relationship between compressive measurements or samples yₖ (k ∈ [1 . . . M]) that are acquired by a compressive imaging device for representing a compressed version of a one-dimensional representation of an N-pixel image x (x₁, x₂, x₃ . . . x_{N}) of a scene is typically expressed in matrix form as y=Ax (as shown below) where A (also known as φ) is a M×N sampling or sensing matrix that is implemented by the compressive imaging device to acquire the compressive samples vector y.

$$[ \begin{matrix}{y}_{1} \\ {y}_{2} \\ {y}_{3} \\ ⋮ \\ {y}_{M}\end{matrix} ] = [ \begin{matrix}{a}_{1} [ 1 ] & {a}_{1} [ 2 ] & … & {a}_{1} [ N ] \\ {a}_{2} [ 1 ] & {a}_{2} [ 2 ] & … & {a}_{2} [ N ] \\ {a}_{3} [ 1 ] & {a}_{3} [ 2 ] & … & {a}_{3} [ N ] \\ ⋮ & ⋮ & ⋮ & ⋮ \\ {a}_{M} [ 1 ] & {a}_{M} [ 2 ] & … & {a}_{M} [ N ]\end{matrix} ] \cdot [ \begin{matrix}{x}_{1} \\ {x}_{2} \\ {x}_{3} \\ ⋮ \\ {x}_{N}\end{matrix} ]$$

It will be understood that the vector x (x₁, x₂, x₃ . . . x_{N}) is a one-dimensional representation of a two-dimensional (e.g., row and column) \sqrt{N}×\sqrt{N} native image, and that known methods, such as concatenating the rows, or the columns, of the two-dimensional image into a single column vector, may be used to mathematically represent the two-dimensional image of known dimensions as a one-dimensional vector and vice versa. The matrix A shown above is also referred to as a maximum length sensing or sampling matrix, since each row (also known as basis vector) has N values that correspond to the reconstruction of the full resolution desired N-pixel image x of the scene.

As noted above, the present disclosure describes systems and methods that are configured for feature or object recognition using compressive measurements that represent a compressed image of a scene. In other words, the various aspects described below are directed to the performing feature extraction or object recognition directly from the compressive measurements yₖ (k ∈ [1 . . . M]). By directly, it is meant herein that the present disclosure describes systems and methods where feature extraction and object recognition are performed from the compressive measurements and without using or reconstructing an N-pixel image (x₁, x₂, x₃ . . . x_{N}) from the compressive measurements.

The systems and methods disclosed herein may be advantageously used in fields of medical imaging, security or in any other field where generating a full native resolution N-pixel image from the compressive measurements may not be necessary or may consume more resources than desired in order to detect objects or features from the compressive captured image of a scene directly. Notably, the systems and methods disclosed herein do not preclude being able to generate the full native resolution image from the acquired compressive samples if it should be desired or necessary to do so.

For convenience, the description of the systems and methods disclosed herein is divided into an acquisition phase and an extraction (or detection) phase. The acquisition phase includes acquiring the compressive sense measurements yₖ (k ∈ [1 . . . M]) that represent a compressed version of a N-pixel image x (x₁, x₂, x₃ . . . x_{N}) of a scene. The acquisition phase includes constructing a compressive sensing matrix in accordance with the principles disclosed herein. The compressive sensing matrix is used to acquire the compressive measurements, such that in the extraction phase, the compressive measurements can be processed for feature point detection and feature vector description in the scene without converting the compressive measurements into the N-pixel image representation of the scene. The feature vectors are used to detect (i.e., recognize) objects in the scene based on comparison with one or more predetermined feature vectors (without using the N-pixel image representation of the scene). These and other aspects of the present invention are now described in more detail below with reference to the figures.

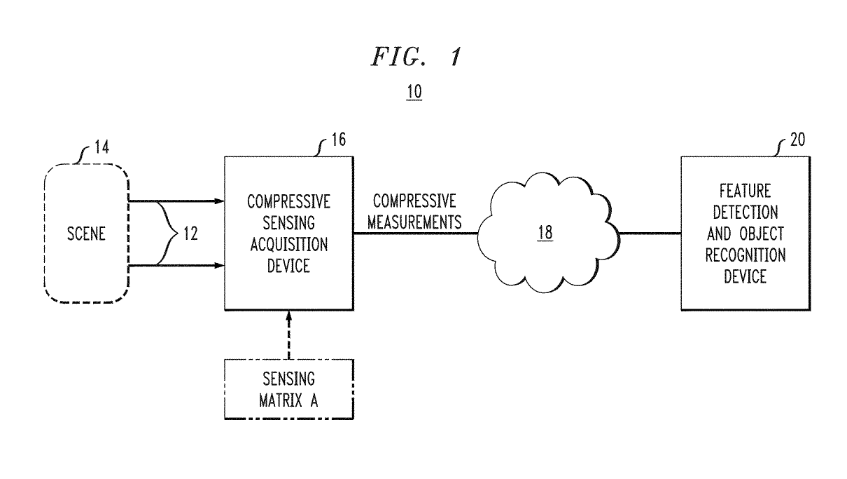

FIG. 1 illustrates a schematic example of a compressive imaging system 10 (“system 10”) in accordance with various aspects of the present disclosure. Incident light 12 (which may be in the visible or non-visible spectrum) reflecting off of a scene 14 is received by a compressive sensing acquisition device 16 (acquisition device), which is configured to use a predetermined sensing matrix A (described in detail further below) to generate a vector y of compressive measurements yₖ (k ∈ [1 . . . M]), where M<<N. The compressive measurements yₖ (k ∈ [1 . . . M]) represent a compressed version of a single native resolution N-pixel image x (x₁, x₂, x₃ . . . x_{N}) (expressed as a one-dimensional representation of a two dimensional \sqrt{N}×\sqrt{N} image, using, for example, concatenation of the rows of the two-dimensional image) of the scene 14.

For example, the incident light 12 reflected off the scene 14 may be received at the acquisition device 16 where the light is selectively permitted to pass, partially pass, or not pass through an N element array of individually selectable aperture elements (e.g., N micro-mirrors) and strike a photon detector (not shown). Which of the N individual aperture elements are partially or fully enabled or disabled to allow (or block) the light to pass through and strike the detector at any particular time is programmably controlled using the compressive sensing matrix A. It is assumed that the compressive sensing matrix A is a predetermined matrix that is constructed in accordance with the aspects of the present disclosure as described in full detail below.

The acquisition device 16 processes (e.g., integrates, filters, digitizes, etc.) the output of the photon detector periodically to produce a set of M compressive measurements yₖ (k ∈ [1 . . . M]) over respective times t₁, t₂, . . . t_{M} using the respective ones of the compressive basis vectors a₁, a₂, . . . a_{M} of a compressive sensing matrix A. The compressive measurements yₖ (k ∈ [1 . . . M]) collectively represent a compressed image of scene 14. In practice, the number M of the compressive measurements that are generated represent a pre-determined balance between a desired level of compression and the desired native resolution of the full resolution N-pixel image that may be reconstructed using the M compressive measurements. In general, M<<N. The acquisition device 16 may be configured based upon such balance.

The vector y of compressive measurements y₁, y₂, . . . y_{M} representing the compressed N-pixel image x₁, x₂, x₃ . . . x_{N} of the scene 14 may be transmitted by the acquisition device 16 over a network 18 to a feature extraction or object recognition device 20.

The feature extraction or object recognition device 20 (recognition device 20) is configured to extract features or detect object in the scene from the compressive sensing measurements yₖ (k ∈ [1 . . . M]) received from the acquisition device 16. In particular, and as described in detail below, the recognition device 20 is configured to detect objects with feature matching in the scene from the compressive measurements yₖ (k ∈ [1 . . . M]) without resorting to or converting the compressive measurements into a pixel representation x (x₁, x₂, x₃ . . . x_{N}) (expressed as a one-dimensional representation of a two dimensional \sqrt{N}×\sqrt{N} image) of the scene.

Although the devices or units are shown separately in FIG. 1, in some embodiments the devices may be combined into a single unit or device. For example, in one embodiment, a single processing device may be configured as a single camera device to provide the functionality both generating the compressive measurements representing a scene and processing the compressive measurements to detect objects within the scene. The single processing device may include (as in the case where the devices are separate), a memory storing one or more instructions, and a processor for executing the one or more instructions, which, upon execution, may configure the processor to provide the functionality described herein. The single processing device may include other components typically found in computing devices, such as one or more input/output components for inputting or outputting information to/from the processing device, including a camera, a display, a keyboard, a mouse, network adapter, etc. The network 17 may be an intranet, the Internet, or any type or combination of one or more wired or wireless networks.

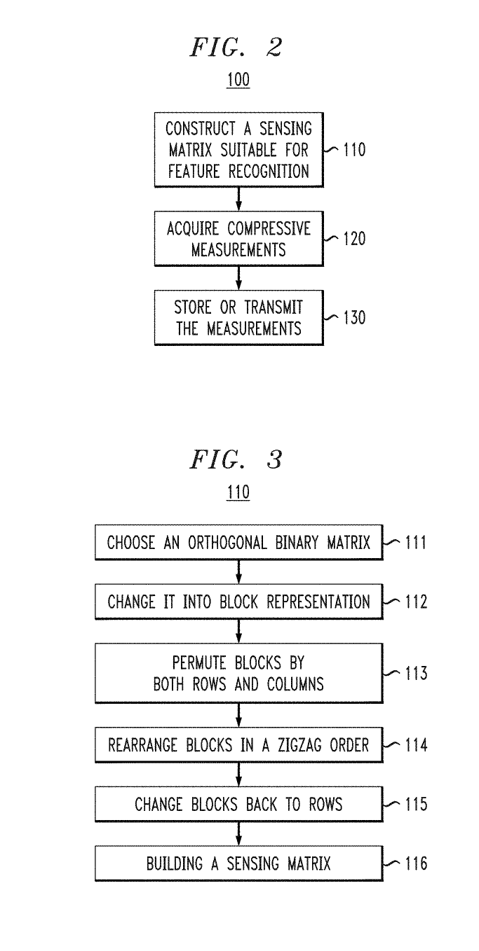

Operational aspects of the compressive sensing acquisition device 16 are now described in conjunction with process flow 100 illustrated in FIG. 2. In step 110 the acquisition device 16 constructs a sensing matrix A that enables feature extraction or object recognition directly from the compressive measurements. The steps for creating a sensing matrix A in accordance with the principles of the present disclosure are described in detail further below. In step 120 the acquisition device 16 acquires compressive measurements yₖ (k ∈ [1 . . . M]) representing a compressed image of a scene using the sensing matrix A that is created in step 110. In step 130 the acquisition device 16 stores or transmits the compressive measurements yₖ (k ∈ [1 . . . M]) for further processing of feature or object detection in the scene by the recognition device 20.

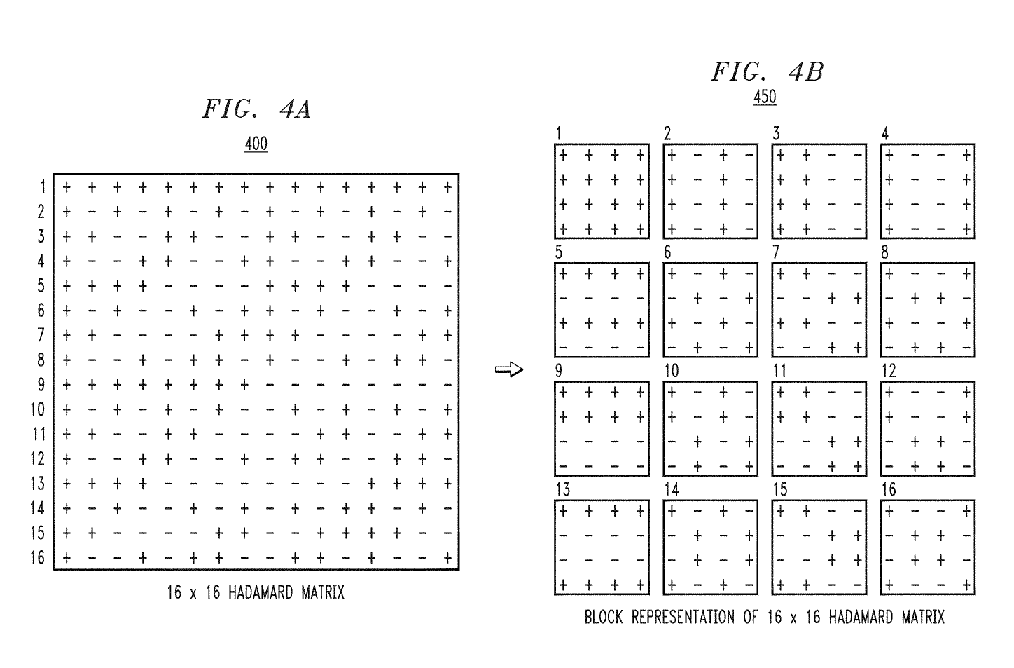

An exemplary description of creating a sensing matrix A (step 110 of FIG. 2) that is suitable for acquiring compressive measurements yₖ (k ∈ [1 . . . M]) that are directly processed for feature extraction or object recognition in accordance with the principles of the disclosure is now described in conjunction with the flow diagram shown in FIG. 3.

In step 111 the acquisition device 16 starts with a selected N×N orthogonal matrix. One example of an orthogonal matrix is the well known Hadamard matrix.

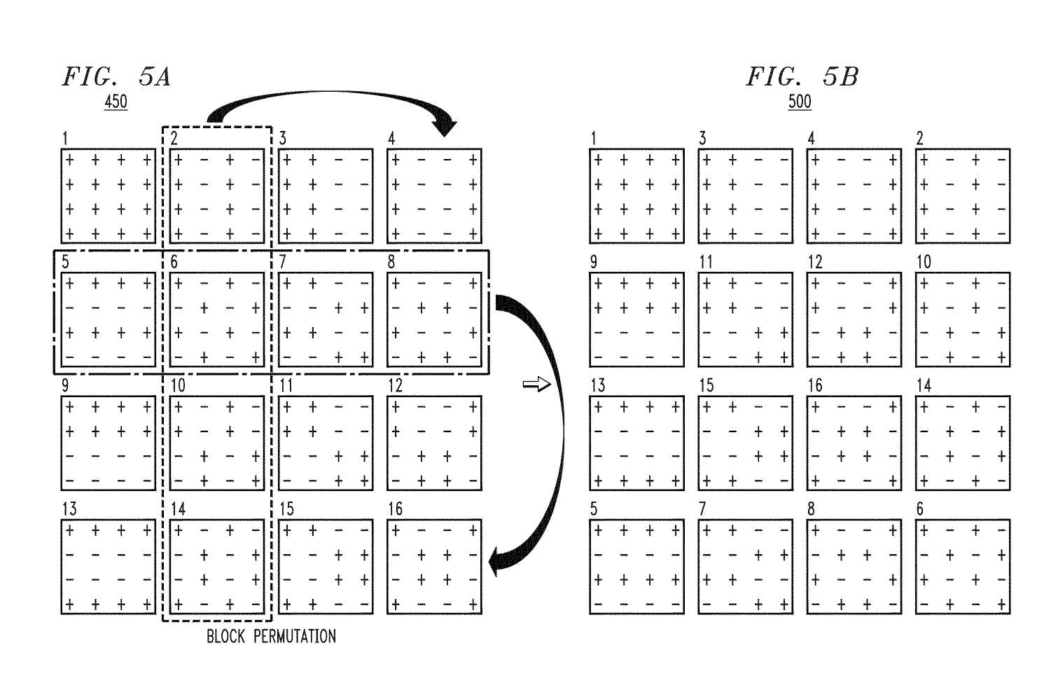

FIG. 4A illustrates an example of 16×16 Hadamard matrix 400 where N is assumed to be 16. As seen in FIG. 4A, the N rows of the Hadamard matrix 400 are orthogonal to each other, and each row has N values. While a particular orthogonal matrix 400 is shown in FIG. 4A to describe the principles of the disclosure, it will be understood that in other embodiment other types of orthogonal matrices may be selected as long as the rows of the matrices are orthogonal to each other. Furthermore, although FIG. 4A illustrates an example of 16×16 Hadamard matrix, in practice the size of the orthogonal matrix would be larger, and in general the selected orthogonal matrix would typically be a N×N matrix where the number N corresponds to the number of elements of the aperture array that is used to acquire the compressive measurements representing the compressed image of the scene as described previously.

In step 112 the acquisition device 16 generates a block representation of the orthogonal matrix selected in step 111. The block representation of the orthogonal matrix is obtained by converting each row of orthogonal matrix into a block and arranging the blocks in a two-dimensional array. The conversion of the orthogonal matrix of step 111 into a block representation in step 112 makes it easier to generate the desired sensing matrix A, as will be apparent further below.

FIG. 4B illustrates the construction of a block representation 450 of the 16×16 Hadamard matrix 400 shown in FIG. 4A. As seen in FIG. 4B, the block representation 450 is generated by taking each row of N elements from matrix 400 and converting the row into a respective \sqrt{N}×\sqrt{N} block, such that the block representation is a set N of ordered \sqrt{N}×\sqrt{N} blocks corresponding to the row order of the orthogonal matrix 400. Stated another way, each row of the orthogonal matrix 400 of FIG. 4A is changed into a respective block such that each row of 16 elements having, for example, values a,b,c,d,e,f,g,h,i,j,k,l,m,n,o,p is changed into a block matrix of ordered values a b c d; e f g h; i j k l; m n o p, where the row vectors of the block representation are indicated herein as being separated by a semicolon. Mathematically, the conversion of each row of the orthogonal matrix 400 into a block representation 450 can be expressed as:

$$( a b c d e f g h i j k l m n o p ) {}^{block representation} ( \begin{matrix}a & b & c & d \\ e & f & g & h \\ i & j & k & l \\ m & n & o & p\end{matrix} )$$

Together, the blocks generated based the row values of the orthogonal matrix 400 constitute the block representation 450 of the orthogonal matrix as shown using indices in FIGS. 4A and 4B.

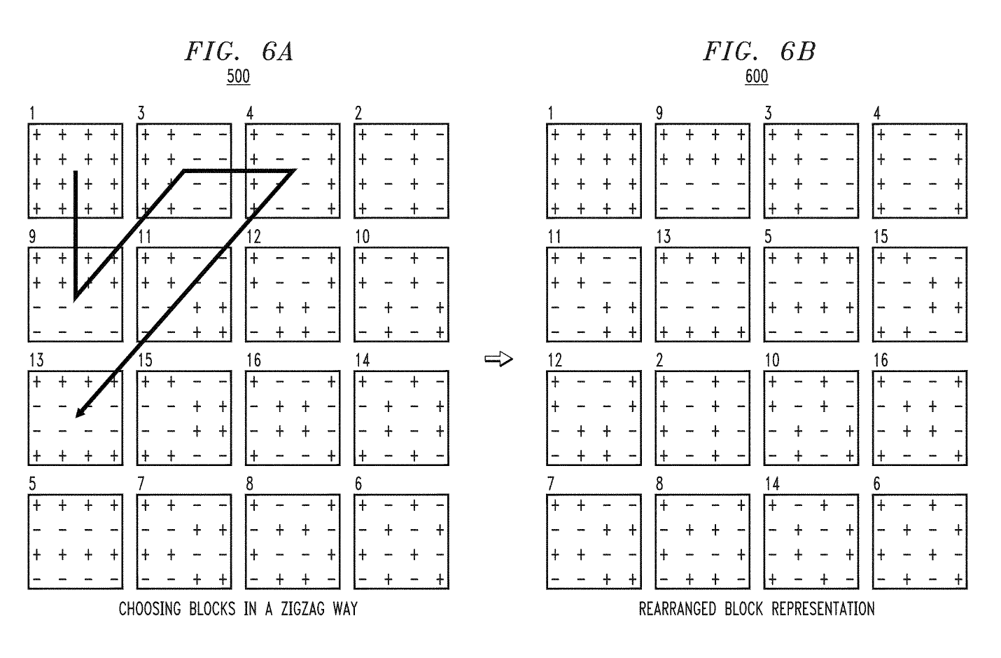

In step 113 the acquisition device 16 determines a frequency for each of the blocks of block representation 450 and permutes the blocks based on the order of frequency. FIGS. 5A and 5B provide an example of permuting the block representation. FIG. 5A illustrates the block representation 450 of FIG. 4. Each block of the block representation 450 is rearranged into the permuted block representation 500 shown in FIG. 5B by applying block permutation based on a determined frequency of the block. As used herein, frequency means the number of sign changes in a block. The number of sign changes or frequency of each block is the count or sum of the number of sign changes in both the horizontal and vertical directions of the block. For example, block 1 shown in FIG. 5A has no sign changes in either the horizontal and vertical directions. Thus, the frequency of block 1 is zero. In contrast, block 3 has one sign change in the horizontal direction and no sign change in vertical direction. Thus, the frequency of block 3 is one because the sum of the numbers of sign changes is one. Similarly, block 4's sum of the numbers of sign changes or frequency can be seen to be two and block 2's sum of the numbers of sign changes of frequency can be seen to be three. To provide some additional examples, block 9's frequency is one and the block 11's frequency is two. Lastly, block 6 has a frequency of six. FIG. 5B thus illustrates permutation of the block representation 450 of FIG. 5A by order of frequency.

In general, block permutation is applied to the block representation 450 to rearrange the blocks in the ascending order of frequency as shown in FIG. 5B. It can be seen in FIG. 5B, for example, that the second row of blocks of block representation 450 is moved, in the permuted block representation 500 based on frequency, to the last order of rows after blocks 13, 14, 15, and 16. Similarly, the second column of blocks of block representation 450 is moved to the last order of columns after blocks 4, 12, 16, and 8 as shown in FIG. 5B. It can equivalently be seen that the second column of blocks is moved to the last order of columns after blocks 4, 8, 12, and 16 and the second row of blocks is moved to the last order of rows after blocks 13, 15, 16, and 14. As seen in FIG. 5A, block 6 of block representation 450 is a shared block in the second row and the second column of block representation 450. Block permutation based on frequency moves block 6 to the last block after permutation, as shown in the permuted block representation 500 illustrated in FIG. 5B.

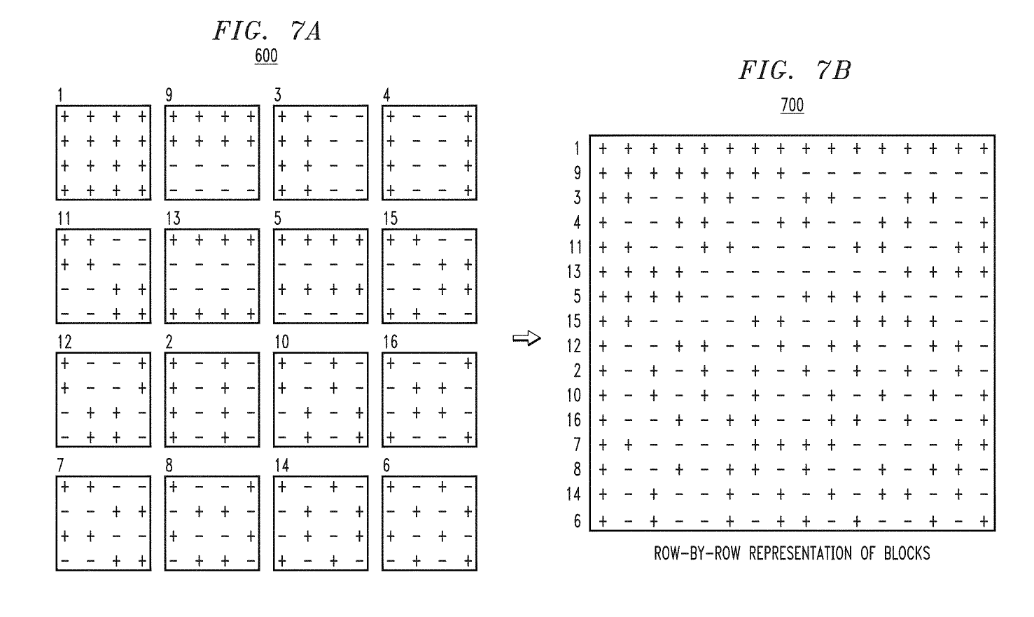

In step 114 the acquisition device 16 further rearranges the permuted block representation of step 113 using a zig-zag line order. FIG. 6A re-illustrates the permuted block representation 500 of FIG. 5B. The result of one possible rearrangement of the permuted block representation using a zig-zag order is shown as the rearranged block representation 600 in FIG. 6B. As seen in FIG. 6A, a zigzag line order may be established for the blocks of the permuted blocks representation 500. Blocks may be selected with the zigzag line order and rearranged as shown by the zig-zag block order representation 600 in FIG. 6B. The first block of FIG. 6B is block 1 of FIG. 6A and the second block is the block 9. Similarly, blocks 3, 4, 11, 13, 5, 15, 12, 2, 10, 16, 7, 8, 14, and 6 follow in order. It will be understood that the permuted block representation 500 may be rearranged differently to achieve different zig-zag representations 600 in other embodiments using a different zig-zag order. For example, in another embodiment the zigzag line order illustrated in FIG. 6A may pass through blocks 1, 3, 9, 13, 11, 4, 2, etc.

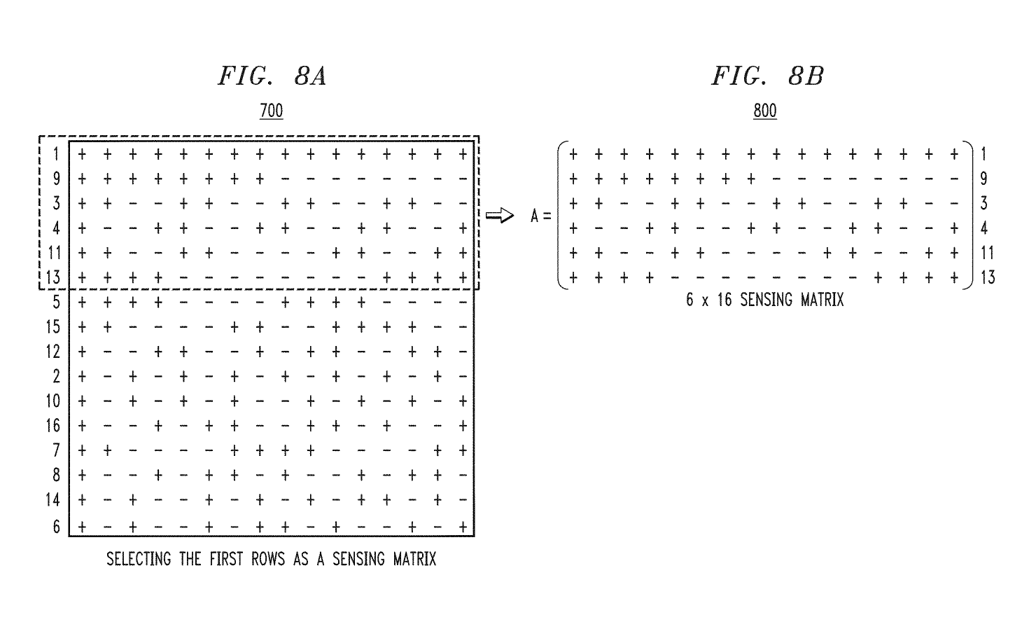

In step 115 the acquisition device 16 converts the zig-zag ordered block representation back into a row matrix. The approach for converting the blocks back into rows is similar to the approach used for converting the rows into blocks. FIG. 7A re-illustrates the zig-zag ordered block representation 600 of FIG. 6B. FIG. 7B illustrates the conversion of the zig-zag ordered block representation 600 shown in FIG. 7A into a row representation 700. Each row of the matrix comes from each of the blocks as shown in the indices.

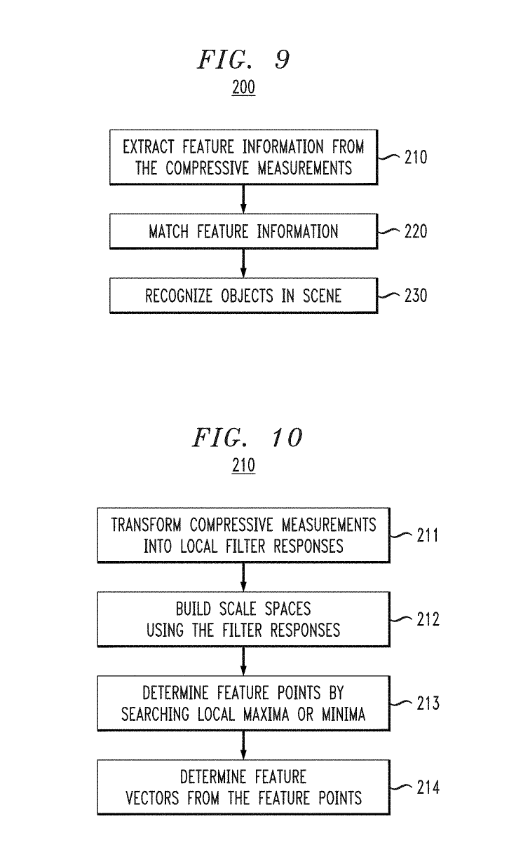

In step 116 the acquisition device 16 selects a predetermined M number of rows from the converted row matrix of step 115, yielding the desired M×N sensing matrix A in accordance with the principles of the present disclosure. FIG. 8A re-illustrates an example selection of the first (or top) 6 rows of representation 700 of FIG. 7B, and FIG. 8B illustrates the final sensing matrix A (800) that is the result of steps 111-116.

It will be understood that the manner of creating the sensing matrix A, as described above in steps 111-116, is one of the features of the present disclosure that enables direct recognition of objects from compressive measurements representing a compressive sensed image without needing to convert the compressive measurements (or compressed image) into a pixel representation of the image in conventional compressive sensing systems.

Returning to FIG. 2 briefly, and having fully described step 110 of process 100, for constructing a sensing matrix A, in step 120 the acquisition device 16 acquires compressive measurements yₖ (k ∈ [1 . . . M]) representing a compressed image of a scene using the sensing matrix A that is created in step 110 in a conventional manner using the relationship y=Ax, as described previously, where x represents a column vector whose components are original signals or, in this invention, the pixel values of the uncompressed image of scene 14, A is the sensing matrix of step 110, and y is the set of compressive measurements yₖ (k ∈ [1 . . . M]) of step 120. Because the number of rows of A is smaller than the number of columns of A, the number of components of y is smaller than the number of components of x, which is why the components of y are “compressive” measurements representing a compressed version of x. Furthermore, in step 130 the acquisition device 16 stores or transmits the compressive measurements yₖ (k ∈ [1 . . . M]) for further processing of feature or object detection in the scene by the recognition device 20.

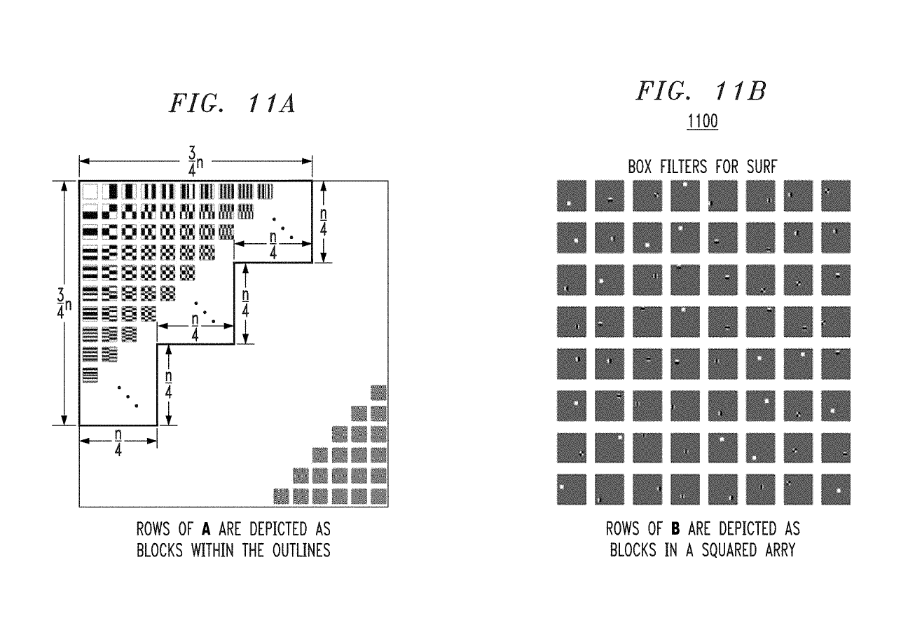

Operational aspects of the compressive sensing based feature extraction or object recognition device 20 are now described in conjunction with process 200 illustrated in FIG. 9. In step 210 the recognition device 20 extracts feature information from the compressive measurements yₖ (k ∈ [1 . . . M]) that are received from the acquisition device 16. In step 220 the recognition device 20 matches the extracted feature information with a predetermined set of features. In step 230 the recognition device 230 identifies objects in the scene 14 based on a match between respective ones of the features that are extracted from the compressive measurements yₖ (k ∈ [1 . . . M]) and one or more of the predetermined set of features. It is noted that the object recognition device 20 performs steps 210-230 without needing to convert the compressive measurements yₖ (k ∈ [1 . . . M]) into the pixel representation x (x₁, x₂, x₃ . . . x_{N}) of the scene.

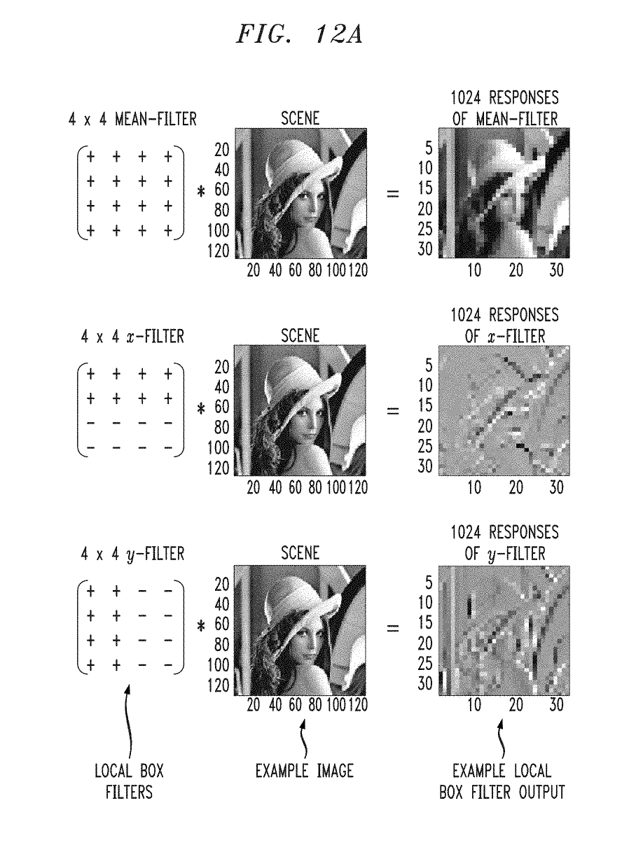

An exemplary description of extracting feature vectors (Step 210 of FIG. 9) from the compressive measurements yₖ (k ∈ [1 . . . M]) for object recognition in accordance with the principles of the disclosure is now described in conjunction with the flow diagram shown in FIG. 10. The steps of FIG. 10 may be advantageously implemented to detect and describe features in conjunction with conventional algorithms like, for example, the SURF (Speeded Up Robust Features) and SIFT (Scale Invariant Feature Transform) algorithms.

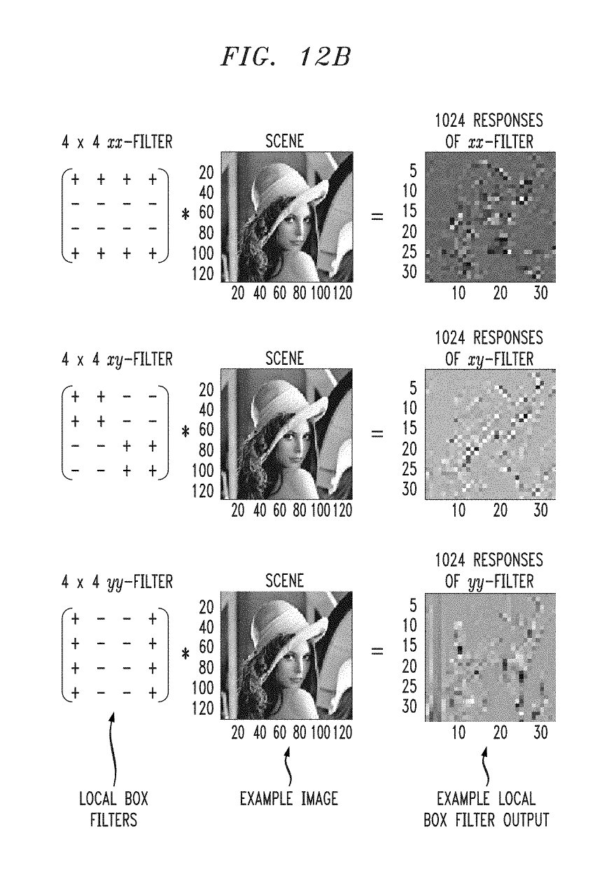

In step 211 of FIG. 10, the recognition device 20 transforms the compressive measurements yₖ (k ∈ [1 . . . M]) acquired in step 120 using the sensing matrix A constructed in step 110 into a set of filter responses r using a predetermined set of filters B (e.g., for the SURF algorithm). The filter responses r are local gradient information, which will be used to detect feature point and describe feature vector, and are computed by using a predetermined set of filters B or, equivalently, r=Bx. FIG. 11A illustrates an example of a sensing matrix A in which each row of the sensing matrix is visually depicted as a block within the outlines of FIG. 11A. More particularly, the blocks shown within the outlines in FIG. 11A represent the rows of the sensing matrix A constructed in step 116 and exemplified in representation 800.

FIG. 11B illustrates an example block set of filters B (1100) that are constructed in accordance with the principles of the present disclosure, for in this example, the SURF algorithm. Each filter or, equivalently, each row of B includes one of six different types of local box filters. The six types of local box filters include the mean filter, the first order derivative filter in the x-direction, the first order derivative filter in the y-direction, the second order filter in the xx-direction, the second order filter in the yy-direction, and the second order derivative filter in the xy-direction. All filter representation is binary with +1 and −1/0. In the embodiment shown in FIG. 11B, the dark areas in block filters B represent a binary value of 0. Furthermore, the light areas in the block filters represent a binary value of 1. The size of each block filter B corresponds to the size of each row of the sensing matrix A.

In step 211, the recognition device 20 decomposes or transforms the compressive measurements yₖ (k ∈ [1 . . . M]) using the sensing matrix A or y=Ax into a set of local filter responses r using the set of block filters B (1100) or r=Bx. Adding and subtracting blocks, which are shown as being arranged within the outlines in FIG. 11A, lead to the small local box filters in the set of filters B (1100) in FIG. 11B, as will be understood. Mathematically, the correlation between the sensing matrix A of step 110 and the set of local box filters B (1100) of FIG. 11B is CA=B, where A is the sensing matrix constructed in step 110, the resulting block filters 1100 are described in rows of the matrix B, and transformation between the local filters 1100 and the sensing matrix A is given by the matrix C (as determined by the recognition device 20). In other words, starting y=Ax as described previously, the recognition device 20 is configured to compute r=Bx=(CA)x=C(Ax)=Cy, where y is the acquired set of compressive measurements of step 120, A is the sensing matrix constructed in step 110, and r is the determined set of local filter responses of step 211. In particular, r is determined as Cy, where C represents the transformation between the sensing matrix A and the set of filters B (e.g., for the SURF algorithm) that are shown in FIG. 11B.

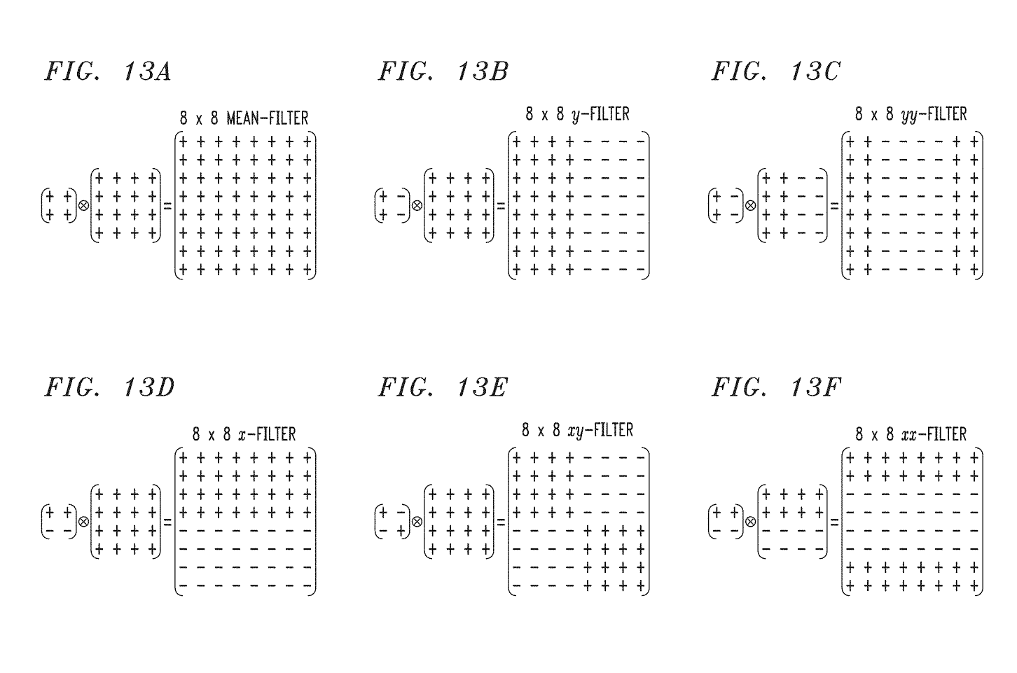

FIGS. 12A-12B illustrate an exemplary embodiment of each of the six types of binary local box filters in accordance with the principles of the disclosure, namely the binary mean filter, the binary first order derivative filter in the x-direction, the binary first order derivative filter in the y-direction, the binary second order derivative filter in the xx-direction, the binary second order derivative filter in the yy-direction, and the binary second order derivative filter in the xy-direction. The +(plus) symbol indicates a value of 1 in the local box filter. The −(minus) symbol indicates a value of −1 or 0 in the local box filter. Each of the six types of binary local box filters is a 4×4 matrix of binary values as seen in FIGS. 12A & 12B, which means that the smallest size of the local box filters is normally 4×4 in the present disclosure.

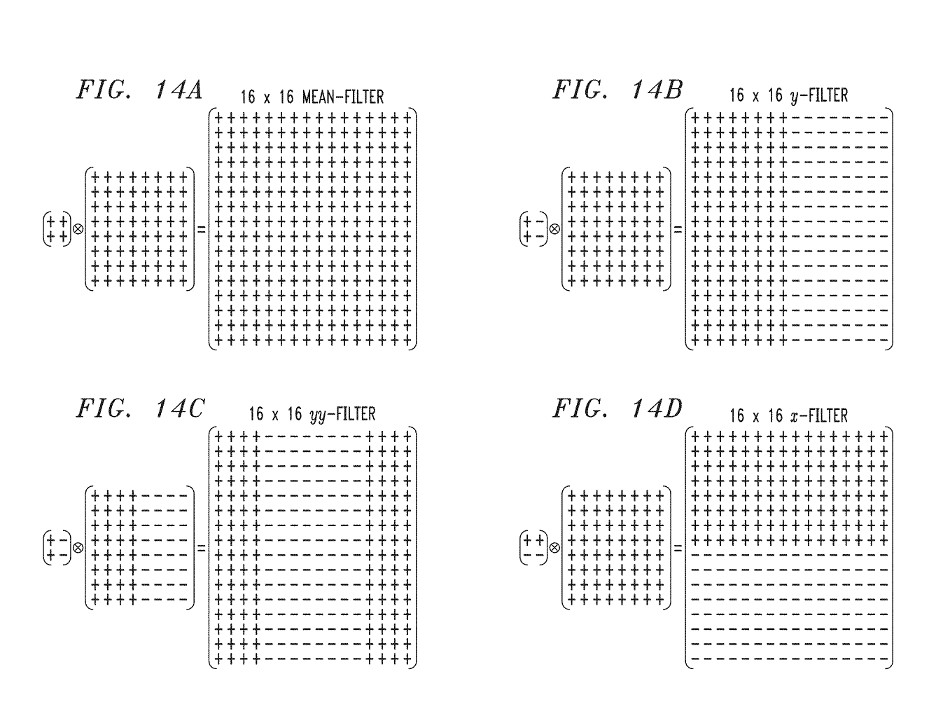

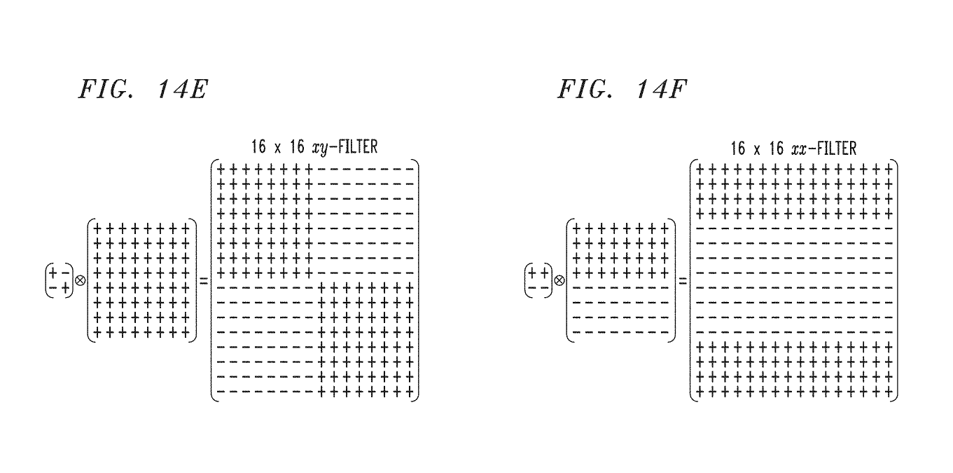

FIGS. 12A-B also illustrate an example of the resulting output of applying each of the six types of binary local box filters to an example pixel image. Although the exemplary embodiment illustrates binary local box filters, in other embodiments the local box filters may be grayscale derivative filters. Although the smallest size of the local box filters is 4×4in the present disclosure, in some embodiments, the size of the binary local box filters may be increased to 8×8, or 16×16 etc. for very large images. A larger size local box filter may be obtained by Kronecker product as shown in FIGS. 13A-13F and 14A-14F. The definition of local filters is consistent with the filter size. As seen in FIGS. 13A-13F, six 8×8 binary local box filters may be constructed via a Kronecker product between the six 4×4 filters and four 2×2 binary kernel matrices: [+ +; + +], [+ +, − −], [+ −; + −], and [+ −; − +]. As before, the +(plus) symbol in the 2×2 kernel matrix represents a value of 1, and a −(minus) symbol in the 2×2 kernel matrix represents a value of −1/0. Similarly, and as seen in FIGS. 14A-14F, six 16×16 binary local box filters may be constructed using the 8×8 filters shown in FIGS. 13A-13F and the same Kronecker product with the four 2×2 binary kernels: [+ +; + +], [+ +, − −], [+ −; + −], and [+ −; − +]. In general, six larger-sized local box filters such as 8×8, 16×16, 32×32, etc. may be constructed recursively via a Kronecker product with the four 2×2 kernels. Although six filters may be enlarged as described above for very large images, it is a feature of the present disclosure that the six 4×4 filters have been found to be a sufficiently small base size for typical applications. As well understood by one of ordinary skill in the art, the Kronecker product operation is mathematically defined as:

$$Kronecker Product \text{:} ( \begin{matrix}a & b \\ c & d\end{matrix} ) ⊗ ( \begin{matrix}p & q \\ r & s\end{matrix} ) = ( \begin{matrix}a ( \begin{matrix}p & q \\ r & s\end{matrix} ) & b ( \begin{matrix}p & q \\ r & s\end{matrix} ) \\ c ( \begin{matrix}p & q \\ r & s\end{matrix} ) & d ( \begin{matrix}p & q \\ r & s\end{matrix} )\end{matrix} )$$

As with step 110, which is a feature of the present disclosure and describes the construction of the sensing matrix A in accordance with the principles of the disclosure, step 211 is also a feature of the present disclosure and describes determining local box filter responses r that are computed directly from the compressed measurements y (without needing or using x). This is another difference from the prior art (e.g. SURF), in which filter responses are typically determined for the pixel representation x rather than the compressive measurements directly y as disclosed herein.

As will be understood in light of the present disclosure, each row of B illustrates a box filter representation (e.g., for the SURF algorithm). However, because it is assumed herein that x is unknown (and not needed), r cannot be determined using a conventional approach (e.g. integral image method). Thus, the recognition device 20 is configured to compute the conversion matrix C which describes a transformation between the box filter matrix B and the sensing matrix A. The local filter responses r are determined by the recognition device 20 directly using the compressive measurements yₖ (k ∈ [1 . . . M]) as r=Cy as described above.

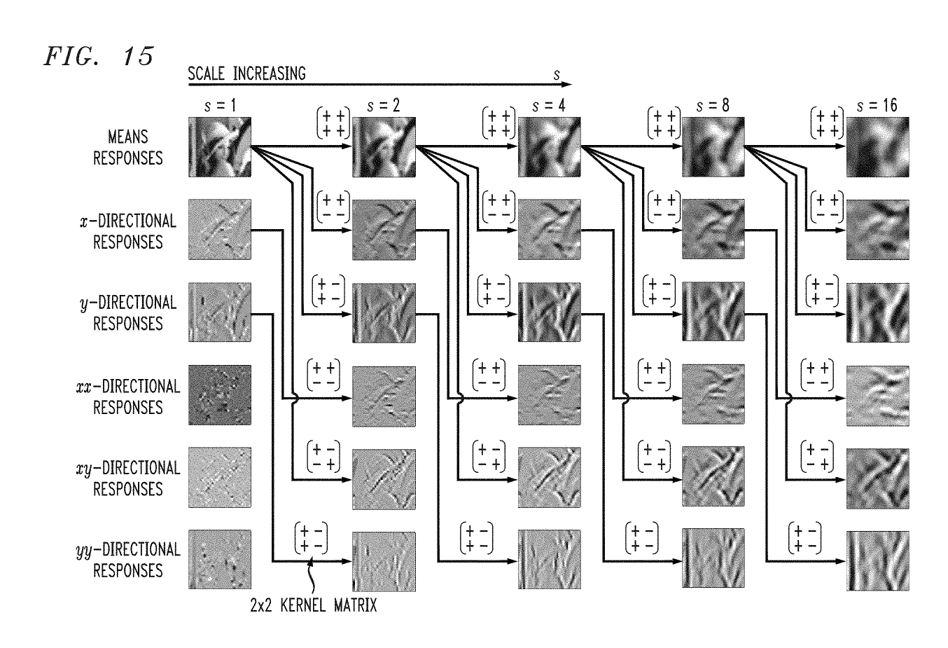

In step 212 the recognition device 20 constructs a discrete scale space using the computed local filter responses r. The scale space is a three-dimensional space of filter responses with regard to the vertical direction, the horizontal direction, and the scale-ascending direction. The scale variable, s, is here discrete. The discrete scale space is constructed by recursively applying the four 2×2 kernel matrices: [+ +; + +], [+ +, − −], [+ −; + −], and [+ −; − +]. FIG. 15 illustrates an example of recursively constructing the discrete scale space for each of the six types of local box filters by using the 2×2 kernels and the computed local filter responses r (which are illustrated as separated filter responses respectively for each of the six local box filters). Each row in FIG. 15 corresponds to a respective one of the six different local box filter types, and each column represents an example set of ascending scales from s=1, s=2, s=4, s=8, and s=16. The arrows represent a convolution operation of a lower scale representation with the illustrated 2×2 kernel matrix (starting initially with the computed local filter responses r for each local box filter type). More particularly, scale s=1 represents the local filter responses r obtained in step 211 that are separated by the local box filter type. Scale s=2 (the second column in FIG. 15) is obtained by convolution of the s=1 column with the illustrated 2×2 kernel matrices. Similarly, s=4 is obtained by convolution of the s=2 column with the same 2×2 kernel matrices and so on for s=8 and s=16. It will be understood that in other embodiments there could be more or fewer number of scales in the computed scale space. In general, it will be understood that the number scales that are constructed in the scale space depends on the image size, and typically the larger the size of the image the greater the number of scales that may be computed.

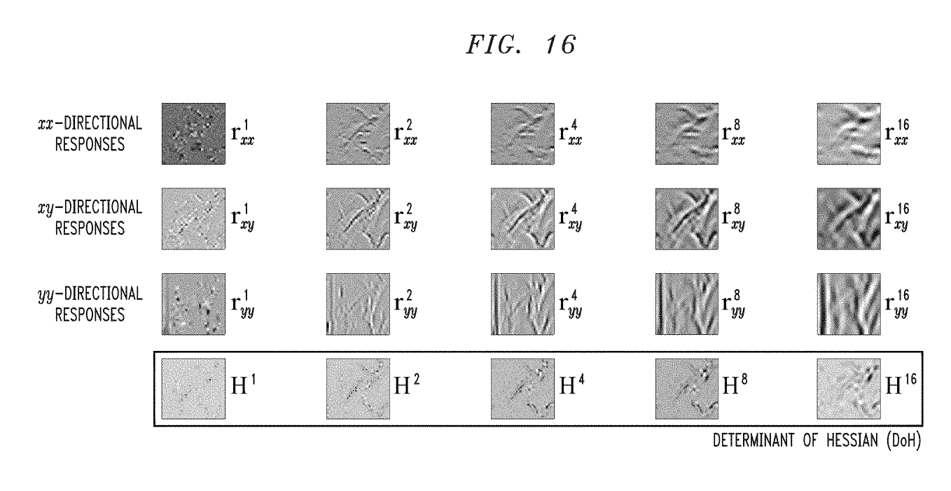

In step 213 the recognition device 20 determines feature points by searching for local maxima and minima in a Determinant of Hessian (DoH) scale space that is computed from the scale space of the second order derivative filter responses computed in step 212. FIG. 16 illustrates an example of determining feature points based on the scale space of the second order derivative filter responses determined in step 212 and illustrated in FIG. 15. As seen in FIG. 16, the computed scale spaces for the second order derivative responses in the xx-, xy-and yy-direction (from step 212) are used to compute the DoH scale space. The DoH scale space is constructed point by point by multiplying the xx-directional scale space with the yy-directional scale space, and by subtracting the result from the xy-directional scale space, as will be understood by one of ordinary skill in the art. The 3D DoH scale space is searched for locations of the local maxima and/or the local minima, which are known in the art as the feature points. Mathematically, determining the 3D DoH scale spaces, such as the H¹, H², H⁴, H⁸, H¹⁶ illustrated in FIG. 16 may be understood as:

H^{s}=rₓₓ^{s}×r_{yy}^{s}−r_{xy}^{s}

where, s=1, 2, 4, 8, 16, . . . , xx, yy, xy designate the second order derivative directions, r^{s} describes the responses of the second order derivative filters in the xx-, xy-, or yy-direction at a scale, s, where r¹ represents the initial local filter responses r obtained in step 211, and H is the computed 3D DoH for the local maxima or minima search.

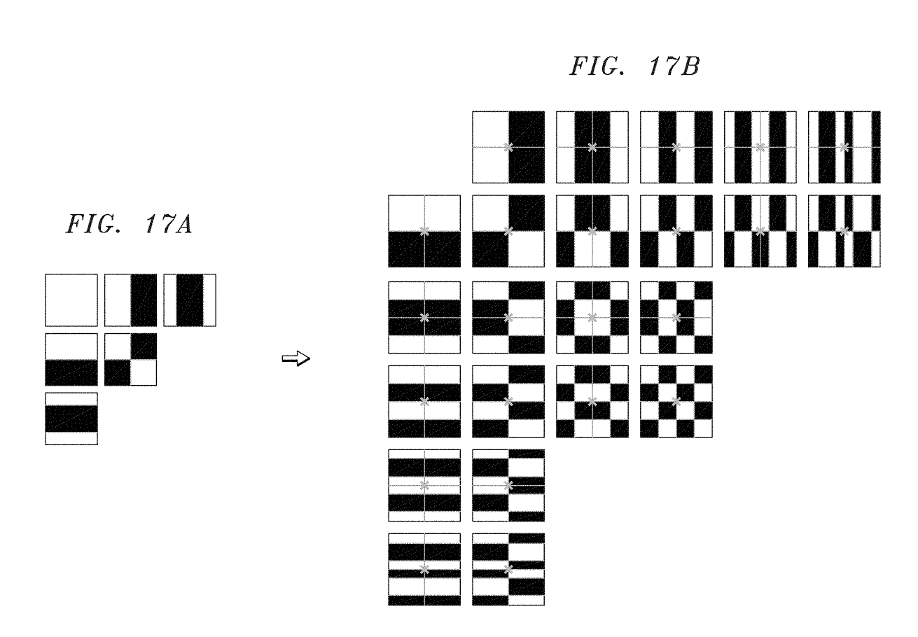

In step 214 the recognition device 20 determines feature vectors on the detected feature points using local descriptive filters exemplarily illustrated in FIGS. 17A and 17B. More particularly, in an exemplary embodiment the recognition device 20 determines a 23-dimensional template feature vector from a set of 23 orthogonal (e.g., Hadamard) patterns, as shown in FIG. 17B, that are generated using 2×2 combinations of a set of six basic local filter representation of FIG. 17A. FIG. 17A visually illustrates the six basic filter local filters, where the dark areas represent a binary value of −1/0 and the light area represents a binary value of 1. The size of the local filters is dependent on the scale that a detected feature point has or where a feature point is detected. The 2×2 possible combinations of the six basic filters originally give a total of 24 orthogonal patterns. But the first illustrated pattern, corresponding to the mean filter, is not used as the feature descriptor, thus resulting in the 23 (=24−1) orthogonal patterns are illustrated in FIG. 17B. The selected 23 patterns shown in FIG. 17B are supposed to be applied as inner product to the local pixel patch of each of the feature points determined in step 213 to construct a 23-dimensional feature vector for each of the determined feature points. However, without the needing to directly apply 23 patterns or local filters to local pixel patch of a feature point, as pixel information is not used in this disclosure, the 23-dimensional feature vector is determined by making the most use of the scale space of the six basic local filter responses as recursively constructed in FIG. 15. For illustration purposes, in FIG. 17B the “x” in each of the selected orthogonal patters indicates the position of a feature point. In general, assuming that N feature points are determined in step 213, in step 214 N feature vectors are generated as described above.

Having fully described the process for obtaining the 23-dimensional feature vectors (Step 220 of FIG. 3), in steps 220 and 230 of FIG. 9 the recognition device 20 may be configured to further process the feature vectors using the conventional SIFT or SURF algorithm to match the feature vectors with a set of predetermined feature vectors to recognize objects in the scene 14.

Advantageously, local feature vectors extracted in accordance with the present disclosure are invariant to image scale or resolution. For instance, a feature vector extracted in 256×256 resolution is invariant even when the image is scaled up with 512×512 resolution. This means that invariant object recognition is achieved irrespective of the size or resolution of an object within the image. This scale invariance property is shared with the state-of-the-art feature detectors/descriptors such as SIFT and SURF. But, as described herein, such scale-invariant local features can be detected and described directly from compressed measurements, without using or needing high-resolution pixel images. In the conventional methods, by contrast pixel images are recovered before using SIFT or SURF to get local scale-invariant features. Since the number of compressed measurements is normally far smaller than the number of pixels, cameras or other imaging devices in accordance with the present disclosure may acquire compressed images and further process or analyze them to achieve object recognition using fewer computational resources such as lower processing power and reduced storage.

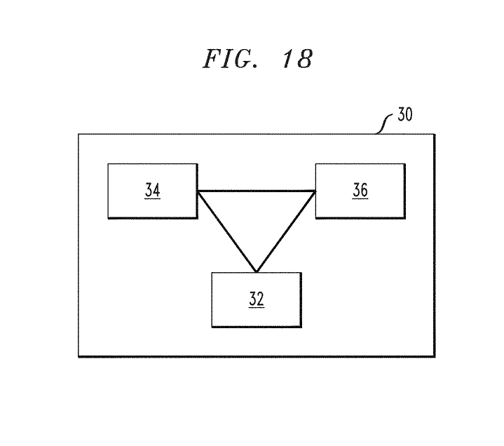

FIG. 18 depicts a high-level block diagram of a computing apparatus 30 suitable for implementing various aspects of the disclosure (e.g., one or more steps of process 100 and or process 200). Computing apparatus 30 may be implemented as part of an image or video camera, a set-top device, a smart phone, a personal computing device, a wearable device, etc. Although illustrated in a single block, in other embodiments the apparatus 30 may also be implemented using parallel and distributed architectures. Thus, for example, one or more of the various units of system 10 of FIG. 1 discussed above, and other components disclosed herein may be implemented using apparatus 30. Furthermore, various steps such as those illustrated in the example of process 100 or 200 may be executed using apparatus 30 sequentially, in parallel, or in a different order based on particular implementations. Exemplary apparatus 30 includes a processor 32 (e.g., a central processing unit (“CPU”)), that is communicatively interconnected with various input/output devices 34 and a memory 36.

The processor 32 may be any type of processor such as a general purpose central processing unit (“CPU”) or a dedicated microprocessor such as an embedded microcontroller or a digital signal processor (“DSP”). The input/output devices 34 may be any peripheral device operating under the control of the processor 32 and configured to input data into or output data from the apparatus 30, such as, for example, an aperture array (e.g., micro-mirror array), an image sensor, network adapters, data ports, and various user interface devices such as a keyboard, a keypad, a mouse, or a display.

Memory 36 may be any type or combination of memory suitable for storing and accessing electronic information, such as, for example, transitory random access memory (RAM) or non-transitory memory such as read only memory (ROM), hard disk drive memory, database memory, compact disk drive memory, optical memory, etc. The memory 36 may include data and instructions which, upon execution by the processor 32, may configure or cause the apparatus 30 to perform or execute the functionality or aspects described hereinabove (e.g., one or more steps of process 100 or 200). In addition, apparatus 30 may also include other components typically found in computing systems, such as an operating system, queue managers, device drivers, database drivers, or one or more network protocols that are stored in memory 36 and executed by the processor 32.

While a particular embodiment of apparatus 30 is illustrated in FIG. 18, various aspects in accordance with the present disclosure may also be implemented using one or more application specific integrated circuits (ASICs), field programmable gate arrays (FPGAs), or any other combination of dedicated or programmable hardware.

Although aspects herein have been described with reference to particular embodiments, these embodiments are merely illustrative of the principles and applications of the present disclosure. It is therefore to be understood that numerous modifications can be made to the illustrative embodiments and that other arrangements can be devised without departing from the spirit and scope of the disclosure. Furthermore, while particular steps are described in a particular order for enabling the reader to more easily understand the various aspects and principles of the disclosure, in some embodiments certain steps may be modified, combined, reordered, or omitted, and in other embodiments additional steps may be added without departing from the principles of the disclosure as will be understood by those skilled in the art.

1. A compressive imaging apparatus, the apparatus comprising:
a processor configured to:
generate an M×N sensing matrix; and
generate a plurality M of compressive measurements representing a compressed version of an N pixel image of a scene using the M×N sensing matrix, each of the compressive measurements being respectively generated by the processor by enabling or disabling one or more of the N aperture elements of an aperture array based on values in respective rows of the sensing matrix and determining a corresponding output of an image sensor configured to detect light passing through one or more of the aperture elements of the aperture array;
wherein the processor is configured to generate the M×N sensing matrix by:
generating a plurality N number of ordered blocks using an N×N orthogonal matrix, each of the generated blocks having a set of \sqrt{N}×\sqrt{N} values selected from the orthogonal matrix, and each generated block being ordered in an ascending order based on a determined frequency of the block;
constructing the M×N sensing matrix by selecting an M number of blocks from the N number of ordered blocks.

2. The compressive imaging apparatus of claim 1, wherein the processor is further configured to:
detect one or more features of the scene from the plurality M of compressive measurements without generating the N pixel image of a scene.

3. The compressive imaging apparatus of claim 1, wherein the processor is further configured to:
detect one or more feature points using the plurality M of compressive measurements;
determine respective feature vectors for the extracted feature points; and,
detect the one or more objects of the scene by comparing the determined feature vectors with one or more predetermined feature vectors of objects.

4. The compressive imaging apparatus of claim 3, wherein the processor is further configured to:
construct a set of local filter responses using the compressive measurements.

5. The compressive imaging apparatus of claim 4, wherein the processor is further configured to:
determine a set of block filters, wherein each block filter in the set of block filters includes one of six types of local box filters, the six types of local box filters including a mean filter, a first order derivative filter in the x-direction, a first order derivative filter in the y-direction, a second order filter in the xx-direction, a second order filter in the yy-direction, and a second order derivative filter in the xy-direction.
determine a transformation matrix between the sensing matrix and the determined set of block filters; and,
construct the local filter responses by applying the transformation matrix to the compressive measurements.

6. The compressive imaging apparatus of claim 5, wherein the processor is further configured to:
determine the set of block filters based on a Speeded Up Robust Features (SURF) algorithm.

7. The compressive imaging apparatus of claim 5, wherein the processor is further configured to:
determine the set of block filters based on a Scale Invariant Feature Transform (SIFT) algorithm.

8. The compressive imaging apparatus of claim 5, wherein the processor is further configured to:
generate a set of scale spaces from the set of local filter responses; and,
extract the one or more feature points using the set of the scale spaces.

9. The compressive imaging apparatus of claim 8, wherein the processor is further configured to:
generate a set of first-derivative directional scale spaces and a set of second-derivative directional scale spaces to generate the set of scale spaces.

10. The compressive imaging apparatus of claim 9, wherein the processor is further configured to:
generate a three-dimensional Determinant of Hessian (DoH) scale space using the constructed set of scale spaces, and,
determine the one or more feature points by finding local maxima or local minima in the generated three-dimensional DoH scale space.

11. A computer-implemented method for compressive sensing, the method comprising:
generating an M×N sensing matrix; and
sequentially generating a plurality M of compressive measurements representing a compressed version of an N pixel image of a scene using the M×N sensing matrix, each of the compressive measurements being respectively generated by enabling or disabling one or more of N aperture elements of an aperture array based on values in respective rows of the sensing matrix and determining a corresponding output of a light sensor configured to detect light passing through the aperture array and provide the corresponding output;
wherein generating the M×N sensing matrix further comprises:
generating a plurality N number of ordered blocks using an N×N orthogonal matrix, each of the generated blocks having a set of \sqrt{N}×\sqrt{N} values selected from the orthogonal matrix, and each generated block being ordered in an ascending order based on a determined frequency of the block;
constructing the M×N sensing matrix by selecting an M number of blocks from the N number of ordered blocks.

12. The computer-implemented method of claim 11, the method further comprising:
detecting one or more features of the scene from the plurality M of compressive measurements without generating the N pixel image of a scene.

13. The computer-implemented method of claim 11, the method further comprising:
detecting one or more feature points using the plurality M of compressive measurements;
determining respective feature vectors for the extracted feature points; and,
detecting the one or more objects of the scene by comparing the determined feature vectors with one or more predetermined feature vectors of objects.

14. The computer-implemented method of claim 13, the method further comprising:
constructing a set of local filter responses using the compressive measurements.

15. The computer-implemented method of claim 14, the method further comprising:
determining a set of block filters, wherein each block filter in the set of block filters includes one of six types of local box filters, the six types of local box filters including a mean filter, a first order derivative filter in the x-direction, a first order derivative filter in the y-direction, a second order filter in the xx-direction, a second order filter in the yy-direction, and a second order derivative filter in the xy-direction.
determining a transformation matrix between the sensing matrix and the determined set of block filters; and,
constructing the local filter responses by applying the transformation matrix to the compressive measurements.

16. The computer-implemented method of claim 15, the method further comprising:
determining the set of block filters based on a Speeded Up Robust Features (SURF) algorithm.

17. The computer-implemented method of claim 15, the method further comprising:
determining the set of block filters based on a Scale Invariant Feature Transform (SIFT) algorithm.

18. The computer-implemented method of claim 15, the method further comprising:
generating a set of scale spaces from the set of local filter responses; and,
extracting the one or more feature points using the set of the scale spaces.

19. The computer-implemented method of claim 18, the method further comprising:
generating a set of first-derivative directional scale spaces and a set of second-derivative directional scale spaces to generate the set of scale spaces.

20. The computer-implemented method of claim 19, the method further comprising:
generating a three-dimensional Determinant of Hessian (DoH) scale space using the constructed set of scale spaces, and,
determining the one or more feature points by finding local maxima or local minima in the generated three-dimensional DoH scale space.
